(19) United States
(12) Patent Application Publication
(10) Pub. No.: US 2026/0236237 A1
(43) Pub. Date: Aug. 13, 2026

(54) UNIVERSAL SELF-HEALING PROGRAMMING INTERFACE

(71) Applicant: Shadowbox, Inc., Carlsbad, CA (US)

(72) Inventors: Gregory A. Stein, Carlsbad, CA (US); Emily A. Deere, San Diego, CA (US)

(21) Appl. No.: 19/051,335

(22) Filed: Feb. 12, 2025

(51) Int. Cl. G06F 8/35

(52) U.S. Cl. CPC G06F 8/35

(57) ABSTRACT

A secure and compliant platform (SCP) can run multiple applications as independent processes within a single user interface. The SCP can automatically detect relevant data fields between the applications and transfer or copy data between the applications. The SCP can crawl the Document Object Model (DOM) of two or more applications, and can identify content blocks in the applications. Artificial intelligence (AI) models can generate mappings of the content blocks of the applications to a shared data dictionary and can be used to detect relevant, similar, or identical content blocks between the applications. The AI models can also detect elements of a data dictionary and/or a mapping to a data dictionary, which can be updated, based on changes or updates to an application DOM, or an endpoint. Generative artificial intelligence (Gen AI) models can generate scripts to automatically update the data dictionary, and/or the mappings to the data dictionary.

### BACKGROUND

### Field

This invention relates generally to the field of artificial intelligence (AI), and more particularly to AI-based program interfaces.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Modern businesses utilize a variety of distinct programming applications in conducting their routine operations. Typically, these programming applications are made by different developers. In many cases, businesses prefer to execute and interact with several distinct programming applications in a single user interface, but also transfer data between the various distinct programming applications, especially between similar or related data fields among those applications. Existing methods of transferring relevant data between distinct and unintegrated programming applications include copying and pasting of the data, or writing custom scripts to transfer relevant, similar, or identical data between applications. These methods can be time-consuming, unreliable, and in some cases, can be in violation of various data regulation or security protocols. Consequently, there is a need for a robust, multi-application platform, which can provide a common user interface to execute multiple programming applications, as well as to robustly transfer relevant data between them.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1 illustrates an environment of a secure and compliant platform (SCP), according to an embodiment.

FIG. 2 illustrates a diagram of the components and processes used in generating and/or updating a data dictionary.

FIG. 3 illustrates a block diagram of finding matching content blocks between two applications and transferring relevant data between the two applications, according to an embodiment.

FIG. 4 illustrates a DOM-based method of finding matching content blocks between distinct applications and transferring relevant data, based on the matching content blocks.

FIG. 5 illustrates a method of updating data dictionaries and other resources of the SCP, according to an embodiment.

FIG. 6 illustrates an environment in which some embodiments may operate.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well-known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Many businesses organize themselves and perform their business function using a variety of software applications. For example, businesses can have payroll applications, human-resources applications, employee database applications, health and insurance applications, marketing, client-management relations (CRM) applications, and other software applications. It is not uncommon for a business to utilize multiple software applications from multiple third parties to perform various operational or administrative functions of the business. While some business functions are integrated into a single application, in many cases, the third-party applications are not natively integrated. For example, employee demographics databases may be handled by a different software application than payroll, or insurance application. In such and similar scenarios, employees using the third-party software applications find themselves transferring data between third-party applications. The transferring of the data can be a simple copy/paste operation, or more sophisticated, where an information technology (IT) department of the business, or a third-party developer, writes code to integrate different applications and/or to transfer data between them. In many instances the code for integration between disparate applications may have to be built by third-parties, or by agreement and collaboration between different software vendors (e.g. an integration between Salesforce® and QuickBooks® can be provided by the developers of those programs or their third-party subcontractors working on an integration solution). Such arrangements typically can introduce additional costs to a business hoping to purchase or use an “integration.” The integration costs, in many instances, are also passed along to the end user, as an embedded cost in the price of the product, or as an add-on, generally increasing the business cost for a user of a program.

In various scenarios, and for different purposes, data may need to be transmitted (copied) between separate distinct applications. For example, a human-resources (HR) department may want to update a payroll application, based on an employee demographics application. In the medical field, often a healthcare provider may want to copy demographics and health data between various applications, including, billing applications, electronic health records (EHR) applications and others.

Transferring or copying of data between different software applications can further be complicated if the data is regulated, or otherwise subject to a security protocol. In these scenarios, even copy/pasting sensitive or regulated data in a clipboard can, in some cases, be in violation of various privacy, or security regulations or protocols. Several examples of privacy and/or security regulations can exist, depending on the jurisdiction and the industry in which a business operates. Examples of governmental regulation include the health insurance portability and accountability act (HIPAA) in the U.S. and the general data protection regulation (GDPR) in Europe. Furthermore, a business may have its own internal security protocols related to transfer of data between distinct applications. In general, many businesses require a transfer of data to be performed with one or more robust security protocols, such as an encryption scheme, firewall, access control, password protection, multi-factor authentication, intrusion detection/prevention, data loss prevention and other security protocols. Consequently, businesses can benefit from an environment or platform, where the platform can facilitate secure and compliant transfer of data between distinct business applications. Furthermore, the platform can be more beneficial when the platform can automatically detect related, similar, or identical data blocks within distinct applications and transfer data between distinct applications, automatically or after obtaining a user confirmation. An example of this scenario is auto populating a form in one application, for example, a payroll or a patient invoice, from a demographics-application, having employees' names and addresses, or patients' names and addresses.

Many modern business applications can be based on, or implemented, as web applications, accessible, via a browser. Other business applications can be implemented as desktop or mobile applications. Similarly, a secure and compliant platform, can be built as a browser application or a desktop application.

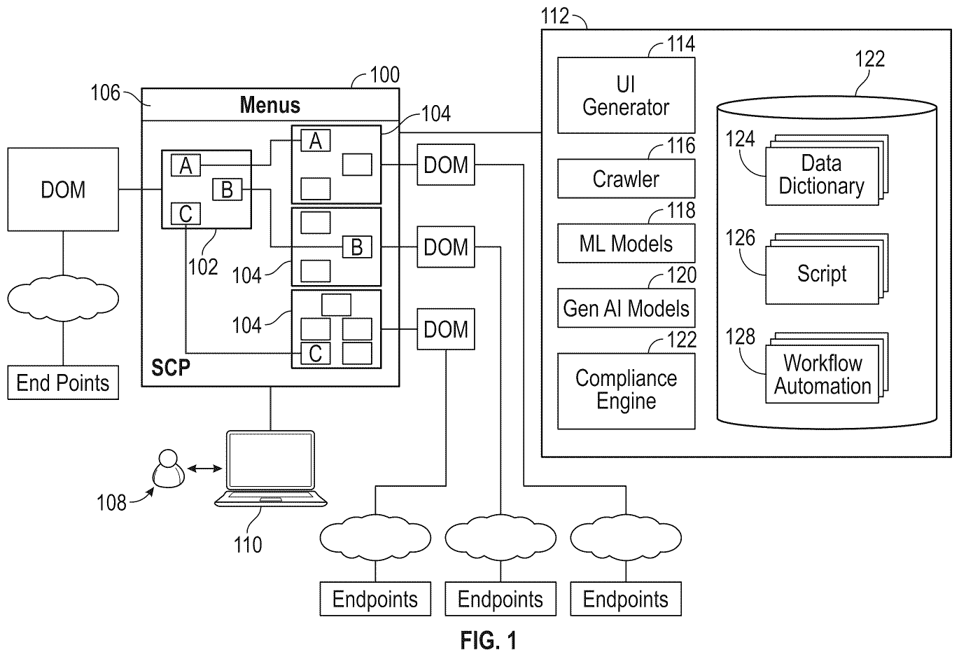

FIG. 1 illustrates an environment of a secure and compliant platform (SCP) 100, according to an embodiment. The SCP 100 can be built as a browser or as a desktop application. While examples of SCP 100 will be described in relation to a browser-based implementation of the SCP 100, not all embodiments are so limited. Persons of ordinary skill in the art can implement the described technology in a desktop or mobile application environment. The SCP 100 can be an environment or a platform, within which several distinct web applications can be executed. The SCP 100 can detect related content blocks within the open applications and transfer data between them. The SCP 100 can implement a variety of robust encryption, and/or security schemes to maintain the security of the data accessed by the applications running in the SCP 100. Additionally, SCP 100 can be made compliant with data privacy regulations. For example, in some industries, such as healthcare, the SCP 100 can omit or can disable regulation-compromising features, such as, “save-as,” “copy,” or “print.”

In the example shown, a user 108 can use a local computer 110 to execute the SCP 100, and one or more distinct third-party web applications therein. The SCP 100 can generate a user interface, displaying the output of the web applications, as well as allowing the user 108 to interact with the web applications. Each application can run in its POD. A POD can include the backend processing environment of the application and the frontend user interface of the application, as generated and provided by the SCP 100. In some implementations, the SCP 100 can alter the default developer-provided backend and/or frontend operations of an application for different purposes, for example, to make an instance of the application regulation-or security-compliant. For example, the SCP 100 can disable the backend and/or frontend operations of the application that enable copying of data to a clipboard. The SCP 100 can also provide menus 106, which can change depending on the implementation of the SCP 100 and the relevant industry. The menus 106 can include typical browsing options, such as “go back,” “go forward,” “refresh,” “user profile icon,” as well as industry-specific menu options. The menus 106 can also include menu options related to configuring the SCP 100 for automatic transfer of data.

In the example shown, a primary application 102 may be the source of truth, from which the user 108 intends to transfer data to one or more secondary applications 104. The SCP 100 can be supported by a backend 112. The backend 112 can be local or remote from the local computer 110. In other words, the backend 112 can be partially, or wholly, implemented locally, or remotely, for example in a cloud infrastructure. The terms “primary” and “secondary” applications are used in reference to an example use case of the SCP 100, where the user 108, configures the SCP 100 to securely transfer data between a source of truth primary application 102, to one or more secondary applications 104. However, the SCP 100 can also be configured to transfer data between a secondary application and a primary application. In other words, the SCP 100 can be configured to transfer data between any two or more applications.

Each web application 102, 104 includes a corresponding document object model (DOM). The DOM lists and outlines the elements of a web page or web application in a tree and node structure. The DOM can be an interface that is accessible with scripting languages, like JavaScript®. The SCP 100 can access the content of a web application by accessing the DOM. Some elements of a web application may not be wholly contained in the DOM. For example, some elements of a webpage may refer to external servers or resources that are accessible, via a network, such as the Internet. The elements of the web applications that are partially external to the DOM can be referred to as endpoints. Some data may only have a reference in the DOM, while the actual data resides securely in an endpoint server. In other words, some endpoints in the DOM are application programming interface (API) calls that allow accessing a server or a resource that stores the data, asset or information referenced in the DOM. Examples of endpoints can include public or private servers, databases, and/or application programming interfaces (APIs). In some cases, the servers, databases, or APIs are provided by the third-party developer who makes the web application 102, 104. The DOM elements and the endpoints can also be referred to as “content blocks.” A content block can include one or more DOM elements, and/or one or more endpoints of DOM elements referenced in the DOM. Accessing the DOM, in the context of the described embodiments, can refer to accessing a content block in the DOM, a content block in an endpoint, or both, depending on where the underlying content resides. In other words, accessing the DOM, in the context of the described embodiments, can also include accessing an external resource, such as an endpoint, referenced in the DOM.

Various backend components support the operations of the SCP 100, including for example, a user interface (UI) generator 114, a crawler 116, machine learning models 118, generative artificial intelligence (Gen AI) models 120 and a compliance engine 122. The SCP 100 can also be supported by a storage 122. The UI generator 114 can generate the UI elements of the SCP 100 in a secure and compliant manner, depending on the relevant industry. For example, regulation-compromising menu items can be removed or disabled in the UI of the SCP 100. One or more crawlers 116 can parse the DOMs of the applications 102, 104 and generate mappings of the DOMs of the applications to a corresponding data dictionary 124. The output of the crawlers 116 can also be used to update an existing mapping to a data dictionary 124. A data dictionary 124 can include a data structure of the terms, definitions and elements an application might encounter or include in a particular industry. For example, the data dictionary can include a listing, or a table of the elements, and/or fields of data in an industry, identification of those elements and/or fields and their definitions in an application in an industry. For example, a data dictionary 124 can include an employee profile elements, and the crawlers 116 can generate a mapping of elements, such as “first_name,” “last_name,” “address” or other demographics information that may be present in the application to the data dictionary. The mapping to the data dictionary 124 may not include the underlying data, but it can include the location and the label of where the data exists in the DOM of the application and/or in an endpoint. In this manner, the mappings and the data structures in a data dictionary can be used to find similar or identical content blocks between two or more applications, by matching elements in the applications'respective mapping to a common data dictionary 124. For example, if both applications include a “first_name” field, as mapped to a common data dictionary 124, that field is a candidate for automatic and/or confirmation-based auto-population or matching between the two applications. In other words, the labeling of the elements of an application, as collected and stored in the mappings to a common data dictionary can be used to find similar or matching data to another application which shares the same data dictionary. In some implementations, data dictionaries 124 can be manually generated and maintained, by a human technician for example, via writing scripts to generate and/or update the data dictionaries, or by manually performing generation, updating and maintenance of the data dictionaries 124.

Some challenges, however, exist, in collecting element labels, and locations, building the data dictionaries, and using data dictionaries for matching and finding relevant fields. First, the developers use inconsistent element labeling schemes. For example, one developer may refer to a “last name” field in their application, as “last_name,” another developer may refer to the same field in their application as “l_name.” Second, not only the label of an element, but other characteristics of the element of an application can be updated and changed. Developers routinely release software patches and updates, changing various characteristics of an element of an application, even deleting an element. The location of an element can be changed with some frequency. Such changes can render a data dictionary, or a mapping to a data dictionary, less useful in finding matching or relevant fields. Some of these challenges can be addressed by manual generation and maintenance of the data dictionaries 124 or the corresponding mappings. However, manual updating of the data dictionaries 124, or the mappings to the data dictionaries, can impact the robustness of the SCP 100. At the very least, the user 108 has to wait for an update to the SCP 100 every time one of the applications 102, 104 have received an update to make sure the relevant data dictionaries 124 are up to date. Consequently, there is a need for an SCP 100 that can automatically update the data dictionaries 124, or the mappings to a data dictionary, without manual intervention, so when the user 108 logs in to the applications 102, 104, the updated data dictionaries 124, and/or the corresponding mappings to the dictionaries 124, can flag or auto populate the relevant or matching data fields between the user applications.

One technique for finding relevant or similar content blocks is screen scraping. A plugin or browser extension can be installed in the browser running the applications. The plugin can capture images of the webpages generated by the applications, perform optical character recognition (OCR) on the images to convert the images to text, parse the text and label a portion of the webpage, based on the text. The labels can then be used to find relevant or matching fields between the applications, running on the browser. In addition to sometimes unreliable outcome of OCRing, screen scraping techniques can be challenging to implement, as developers can change the UI of an application with some frequency. Every time the UI changes, the mappings generated by screen scraping also need to be updated. Compared to screen scraping, generating and updating the data dictionaries 124, based on the DOM offers several advantages. The data dictionaries based on DOM do not include any unreliable data due to OCR, because instead of performing OCR, the data is directly accessed in the DOM. Furthermore, the data dictionaries 124 are not sensitive to the changes in the UI location of the data, as the developer can update or modify the UI location of the data; nonetheless, the described DOM-based data dictionaries 124 would still include a correct mapping of the content blocks, regardless of their UI locations. Unlike the products utilizing screen scraping, the DOM-based data dictionaries 124, as described herein, are not limited to only the information visible to the user in a user interface. A DOM-based data dictionary can be more robust by including application content blocks that are not necessarily displayed or viewed in a user interface by the user or to the user.

The crawler 116 identifies the content blocks in the applications 102, 104. In some embodiments, the crawler 116 can run on a recurring schedule and/or can be activated when the user 108 runs or logs into the applications 102, 104. In some embodiments, the crawler 116 can parse every webpage of every web application and match the content blocks therein against a corresponding data dictionary. Machine learning (ML) models 118 can be trained to identify content blocks in the DOMs of the applications 102, 104, relative to the data dictionaries 124. In other words, the ML models 118 can match the content blocks in a current-version of the applications 102, 104 to the corresponding data dictionaries 124. Discrepancies between the content blocks in the current version of the applications 102, 104 (as reflected in the current DOMs and/or endpoints) and the data dictionaries 124, can arise as a result of the developer of the applications 102, 104 changing their applications, or due to other factors. The crawler 116 can identify the discrepancies and trigger the ML models 118 to determine a relevant content block in the data dictionaries, and/or a corresponding stored mappings to the data dictionaries, that can be updated to resolve the discrepancy. Updating of the data dictionary, and/or the mappings to the data dictionaries, can include various actions, such as revising an elements label, deleting an element label, adding an element label and/or modifying the DOM location of the element in the dictionary and/or a mapping to a dictionary.

Generative artificial intelligence (Gen AI) models 120 can generate scripts 126, based in part on the output of the ML models 118. In other words, the ML models 118 identify which content blocks (e.g., in terms of label name and/or DOM location) in a data dictionary 124, and/or a stored mapping to a data dictionary 124, can be updated to match a current-version of an application 102, 104. The Gen AI models 120 can generate a script 126, accordingly. The script 126, when executed updates the data dictionary 124, and/or one or more content block mappings to the data dictionary 124, to include the updated content block attributes, including for example, the updated label name and DOM location.

In some embodiments, the ML models 118 catalog or categorize the content blocks, so the meaning and significance of a content block can be recorded in the data dictionary 124, and/or the mappings to the data dictionary 124, regardless of the element label chosen by the developer of an application. In this manner, data dictionaries 124, and/or the mappings to the data dictionaries 124, can more robustly match fields, and/or content blocks, between distinct applications. For example, the ML models 118 can catalog various element labels, “last_name,” “l_name,” “lst_name” as the “last name,” element consistently among the data dictionaries 124, and/or the mappings to the data dictionaries 124, thereby allowing matching these fields more robustly. The categorizing performed by the ML models 118 can also trigger a compliance engine 122 to redact, block or otherwise execute content control, related to a set of regulations or security protocols on the content block if the content block is subject to restrictions.

In some embodiments, the Gen AI models 120 can be triggered to generate the scripts 126 when the ML models 118 can exceed a selected confidence level for accuracy. In cases when the crawler 116 is run when a user 108 is present, the crawler can initiate a confirmation process and report the outstanding deficiencies in the mapping between the application and the data dictionary, with the user 108. The scripts 126 are program codes that when executed update the data dictionaries, and/or the mappings to the data dictionaries, based on the output of the ML models 118.

Some embodiments can include workflow automation. As an example, the user 108 may wish to transfer client data from a CRM application to a newly acquired marketing application. The user 108 can activate a record option in the menus 106, or otherwise direct the SCP 100 to record a transfer of data workflow, including which data fields (of potentially many data fields in a primary application) is the user interested in transferring to a secondary application. For example, a CRM application may include hundreds of fields of data. The user 108 can direct the SCP 100 to link and transfer five to ten fields of data from the CRM application to the marketing application. The workflow automation data, including for example the labels of the fields of interest, the locations of the fields and the flow of the data transfer can be stored in workflow automation 128 in the storage 122. Furthermore, the workflow automation 128 can include a field or data mapping from a primary application to one or more secondary applications. The SCP 100 can provide a variety of user interface tools (such as drag and dropping and other techniques) to capture the user-specified data mapping. In some embodiments, when the crawler 116 and the ML models 118 identify a list of changes, the scripts 126 can also update the workflow data in the workflow automation 128, in addition to updating a data dictionary 124, and/or a mapping to a data dictionary 124, based on the list of changes.

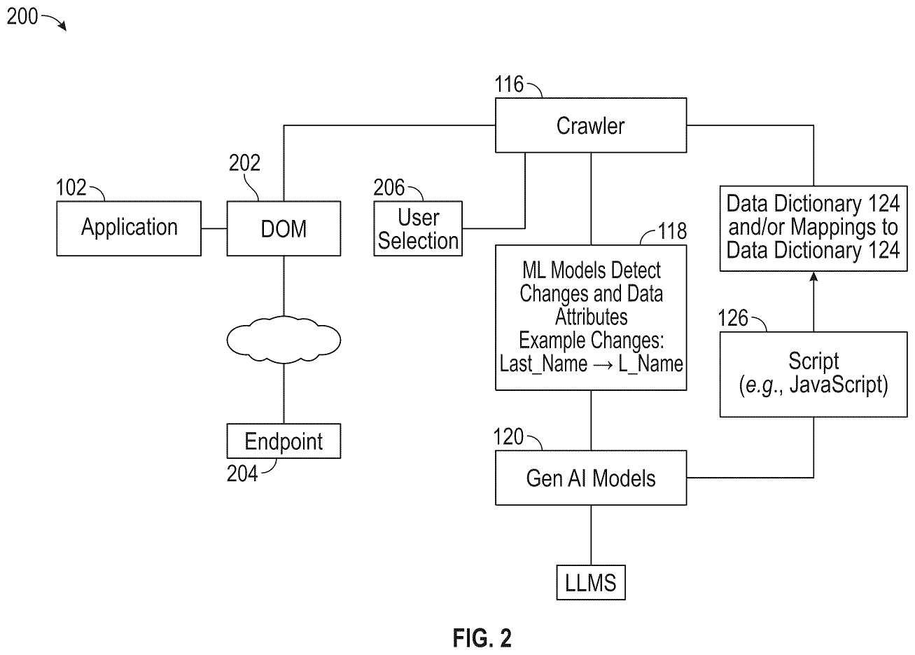

FIG. 2 illustrates a diagram 200 of the components and processes used in generating and/or updating a data dictionary 124 and/or the mappings to a data dictionary 124. The application 102 can have a corresponding DOM 202 and endpoints 204. The crawler 116 can parse the DOM and generate a data dictionary 124 and/or mappings to the data dictionary 124. The mappings can include identifying matches between the content blocks in the application 102 and an industry-specific data dictionary 124, and storing a mapping of the identified content blocks between the application 102 and the data dictionary 124. The data dictionary 124, and/or the mappings to the data dictionary 124, can include a data structure of the content blocks of the application 102 and their DOM locations in relation to the content blocks in the data dictionary 124. In this manner, a mapping of the content blocks of the application 102 in the DOM 202 relative to a data dictionary 124 is identified and stored. In other words, the mapping to a data dictionary 124 can be queried for a content block, and the DOM or endpoint location of the content block in the DOM 202 of the application 102 can be obtained for the purposes of transferring of the data in the content block. The DOM 202 can include hundreds or thousands of elements. Not all DOM elements may be relevant to all users and workflows. In some embodiments, the crawler 116 can receive a user selection 206 of the content blocks that are of interest to the user in terms of matching and data transfer between distinct applications. The crawler 116 can limit the data fields and crawling to only those data fields specified by the user selection 206. The user selection 206 can also be derived from the data in the workflow automation 128.

In some embodiments, the crawler 116 can detect discrepancies or changes between the DOM 202 and the data dictionary 124 and/or the mappings to the data dictionary 124. For example, the developer of the application 102 may have updated the application 102, changing some elements labeling, location or may have added or deleted elements in the application 102. The changes are typically reflected in the DOM 202. In other words, when the application 102 changes, the corresponding DOM 202 also changes. The crawler 116 can detect a change or discrepancy between the DOM 202 and the data dictionary 124 and/or the mappings to the data dictionary 124.

The crawler 116 can trigger the ML models 118 to determine more details about the change or discrepancy between the DOM 202 and the data dictionary 124, and/or a mapping to a data dictionary 124. For example, the ML models 118 can detect that the element “last_name” in the data dictionary 124, and/or a mapping to a data dictionary 124, has been revised to “l_name.” Another change can include a change in some attributes of a data field. For example, a prior version of the DOM 202 may have allocated a field with one character to a “middle_initial” field, while a current version of the DOM 202 may have changed the name of the field to “middle_name” and has changed the allocation of number of letters to twenty, perhaps intending to capture a full middle name. The ML models 118 can generate a list of elements that are changed in the DOM 202, a list of their likely matches in the data dictionary 124, the type of change and the content of the change. For example, the list can include changes in the DOM location of a content block, attributes of the content block (e.g., now 20 characters instead of one), the label of the content block (e.g., now “middle_name” instead of “middle_initial”), and so forth.

The ML models 118 can also be trained to detect and label the content blocks that are subject to content control. For example, ML models 118 can detect and label the content blocks having personally identifying information (PII), or personal health information (PHI), or sensitive financial information, etc. The compliance engine 122 can run scripts, so that the SCP 100 handles those content blocks with an appropriate content control. For example, the compliance engine 122 can cause the SCP 100 to block PHI content or redact them.

The ML models 118 can provide a list of changes to the Gen AI models 120. The Gen AI models 118 can use large language models (LLMs) to generate script 126. Script 126 is a programming code that, when executed, updates the data dictionary 124, and/or a mapping to a data dictionary 124, by incorporating the changes in the change list generated by the ML models 118. For example, the Gen AI models 120 can generate JavaScript code that, when executed, parses the data dictionary 124, and/or a mapping to a data dictionary 124, and replaces every instance of the label of the content block “middle_initial” with the new label “middle_name,” now having twenty-character field length, as opposed to one. In this manner, after running the script 126, the data dictionary 124, and/or a mapping to a data dictionary 124, is updated to match the DOM 202. The updated data dictionary 124, and/or a mapping to a data dictionary 124, can be used to find matching content blocks between the application 102 and other applications. In some embodiments, the Gen AI models 120 can generate scripts 126, directed to updating workflow automation 128, based on the list of changes received from the ML models 118. In other words, in addition to parsing and replacing and updating content blocks in the data dictionary 124, and/or a mapping to the data dictionary 124, the scripts 126 can also parse and replace or update the instances of the content blocks in the workflow automation 128, so the user does not have to re-define or re-record a workflow automation data.

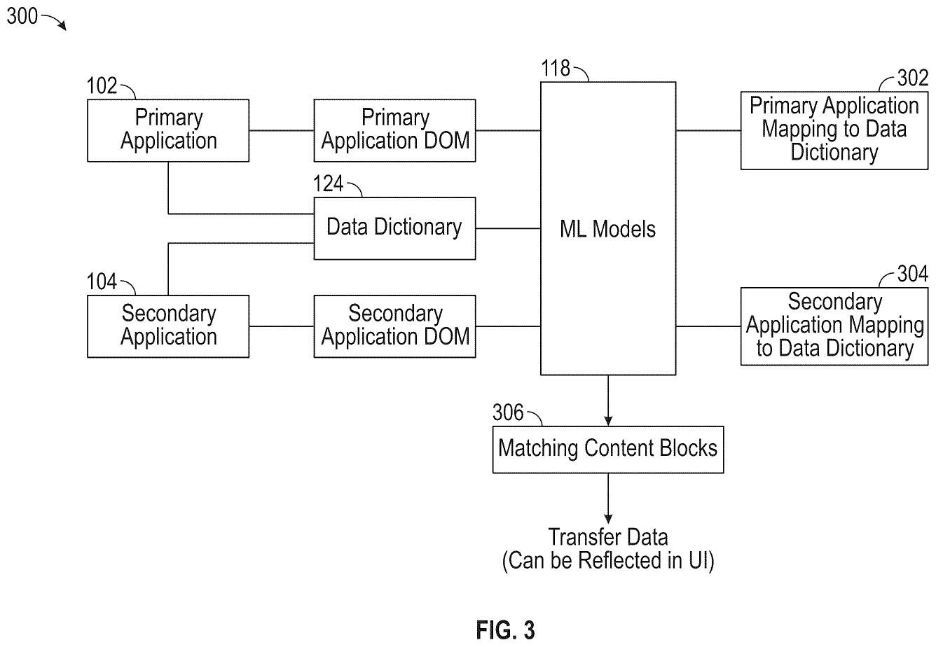

FIG. 3 illustrates a block diagram 300 of finding matching content blocks between two applications and transferring data between the two applications. The primary application 102 has a corresponding data dictionary 124. The secondary application 104 corresponds to the same data dictionary 124. From the primary application DOM, the ML models 118 can generate a primary application content block mapping 302 to the data dictionary. From the secondary application DOM, the ML models 118 can also generate a secondary application content block mapping 304 to the data dictionary. The ML models 118 can also monitor the DOMs and update the mappings 302, 304 when the DOMs change. The mappings 302, 304 include an identification and recordation of content block matches between the applications 102, 104 and the data dictionary 124. The data dictionary 124 is generated and/or updated with consistent labeling, where across all elements of the data dictionary 124, the same label is used to refer to the same content or content block. The mappings 302, 304 can include exact matches, but also matches, determined by the ML models 118, based on the significance and the meaning of the contents of the content blocks, even when the content blocks may have different labels. For example, the ML models 118 can match a content block labeled “middle_initial” in the primary application with a content block labeled “middle_i,” in the secondary application. In other words, the ML models 118 can generate the mappings 302, 304 in a manner that even the differently-labeled content blocks, that refer to the same content, can be mapped to the same content block in the data dictionary 124.

The mappings 302, 304 can indicate which content blocks in the secondary application are the same content blocks in the primary application, and can therefore be the subject of data transfer between the two content blocks. The ML models 118 can generate matching content blocks 306, based on the elements of the mappings 302, 304 that correspond to the same element or content block in the data dictionary 124. The matching content blocks 306 can be the blocks to and from which the SCP 100 transfers data. For example, the SCP 100 can transfer content from a matched content block in the primary application 102 to a corresponding matched content block in the secondary application 104. The ML models 118 can generate an accuracy or confidence score corresponding to each match found. For matches with lower than a selected confidence score, a user confirmation can be obtained before any transfer of data between the two content blocks is performed. Alternatively, the low confidence matches can be ignored.

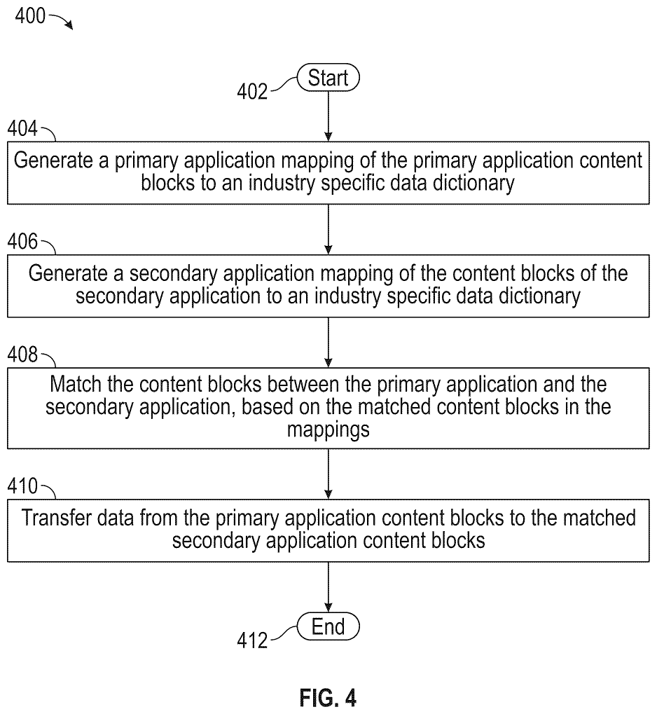

FIG. 4 illustrates a DOM-based method 400 of finding matching content blocks between distinct applications and transferring data, based on the matching content blocks. As an example, the method 400 can identify matching content blocks between a primary application and one or more secondary applications. In some embodiments, one or more industry-specific data dictionaries can be generated, which can be the basis for transferring data, using the method 400. Industry-specific data dictionaries can include tables, lists, vectors, matrices, or other data structures of terms, definitions, concepts, and content blocks that may be used in an industry. In other words, an industry-specific data dictionary is a formalized collection of definitions, concepts, and data structures relevant to a particular sector, designed to standardize terminology and provide clarity in data management practices. It serves as a comprehensive reference guide that outlines key data elements, their attributes, and relationships within the industry, making it easier for organizations to align their data practices with industry standards.

As an example, a healthcare data dictionary can include several data structures, such as “patient information,” “encounter details,” “treatment information,” “billing information,” and others. Each data structure can include sub data structures or underlying elements. For example, the “patient information” data structure can include elements and definitions such as “Patient ID: Unique identifier for each patient (e.g., alphanumeric code),” “First Name: Patient's given name (e.g., string),” “Last Name: Patient's family name (e.g., string),” “Date of Birth: Patient's birth date (e.g., date format: YYYY-MM-DD),” “Gender: Patient's gender (e.g., string, options: Male, Female, Other). An “encounter details” data structure can include elements and definitions, such as “Encounter ID: Unique ID for each patient encounter (e.g., alphanumeric code),” “Encounter Date: Date of the patient visit (e.g., date format: YYYY-MM-DD),” “Reason for Visit: Brief description of the patient's complaint (e.g., string),” “Diagnosis Code: Code representing the diagnosis (e.g., ICD-10 code),” and “Provider ID: Unique identifier for the healthcare provider (e.g., alphanumeric code).” The “treatment information” data structure can include elements an definitions such as “Treatment ID: Unique identifier for each treatment provided (e.g., alphanumeric code),” “Treatment Type: Description of the treatment (e.g., string, options: Medication, Surgery, Therapy),” “Start Date: Date when the treatment commenced (e.g., date format: YYYY-MM-DD),” “End Date: Date when the treatment concluded (e.g., date format: YYYY-MM-DD),” and “Dosage: Amount of medication prescribed (e.g., string, e.g., 500 mg).” The “billing information” data structure can include elements and definitions such as “Bill ID: Unique identifier for each bill (e.g., alphanumeric code),” “Claim Status: Status of the insurance claim (e.g., string, options: Pending, Approved, Denied),” “Total Amount: Total charge for services rendered (e.g., decimal),” and “Insurance Provider: Name of the insurance company (e.g., string).”

Similarly, a payroll data dictionary can include terms, definitions, data structures, content blocks and elements, associated with or used in the payroll industry. Example content blocks can include accounting terminology, used in the payroll industry and their associated definitions in terms of what data structure format the content blocks should assume in a relevant computer program. Similarly, other examples of industry-specific data dictionaries can be generated for human resources, financial institutions, recruitment agencies, marketing departments, and other business sectors. Data dictionaries and/or industry-specific data dictionaries in the context of the described embodiments can alternatively be referred to as data models, or canonical data models (CDMs).

The method 400 starts at step 402. Step 404 includes generating a primary application mapping of the content blocks in a primary application to the content blocks in an industry-specific data dictionary. The primary application mapping can be generated based on the primary application DOM and the endpoints referenced therein. The primary application DOM and/or the endpoints, referenced therein, can be monitored and the primary application mapping can be updated, based on the changes in the DOM and/or the endpoints. Step 406 includes generating a secondary application mapping of the content blocks in the secondary application to the industry-specific data dictionary, used in step 404. The secondary application mapping can be generated, based on the secondary application DOM data and the endpoints referenced therein. The secondary application DOM and/or the endpoints referenced therein can be monitored and the secondary application mapping can be updated, based on the changes in the DOM and/or the endpoints. The step 406 can be repeated for multiple secondary applications, generating a corresponding data dictionary mapping for each secondary application. Step 408 includes matching content blocks between the primary and secondary applications, based on the matched content blocks in the primary and secondary mappings. The matched content blocks between the primary and secondary mappings are determined and/or identified as they correspond to and match the same content block in the industry-specific data dictionary, used in steps 404, 406. While some content blocks may be identical matches. The ML models 118 can find matching content blocks that may have different labels, but share the same significance, meaning or underlying data nonetheless. Step 410 includes transferring data between the primary application content blocks to the matching secondary application content blocks. In some embodiments, the transfer of data is based on the workflow data in the workflow automation 128. The transfer of data can also include accessing the content or the data in a matched content block region of the primary application DOM, and injecting the accessed content or data in the secondary application DOM, in the matched content block regions of the secondary application DOM. In other words, the transfer of data can also be by accessing and injecting the data in the matched content regions of the respective application DOMs. The method ends at step 412.

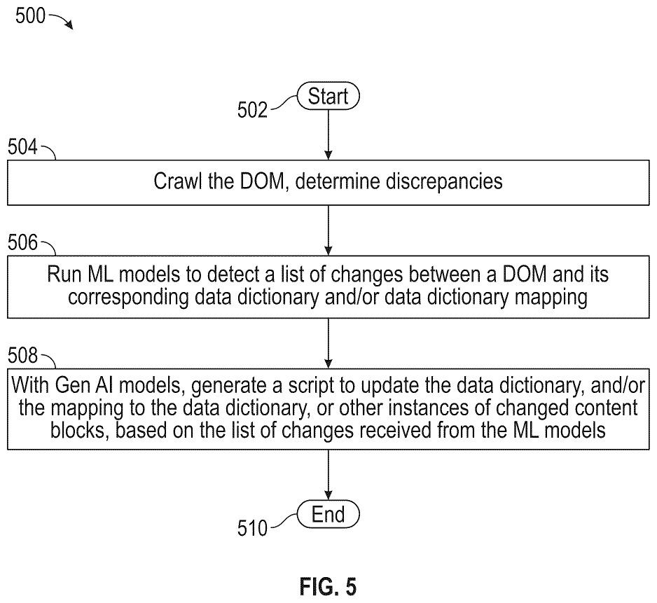

FIG. 5 illustrates a method 500 of updating data dictionaries, mappings to the data dictionaries, and other resources of the SCP 100. The described artificial-intelligence-based updating allows the method 400 described in relation to FIG. 4 to be performed more accurately and more robustly. Performing the method 500 also reduces or minimizes the need for manual updating of the data dictionaries, the mappings to the data dictionaries, automation workflow data, and other resources of the SCP 100. The method 500 starts at step 502. Step 504 includes the crawler 116 crawling the DOM of an application. The crawling can be scheduled to be performed on a recurring basis, and/or it can be triggered when the user 108 logs in, or otherwise executes the application. The crawler 116 can search for instances of discrepancy between the current DOM data of an application and its corresponding data dictionary and/or data dictionary mapping. If such discrepancies are detected, the crawler can trigger the ML models 118 to find more details on the discrepancies, for example, by predicting potential content blocks in the data dictionary, and/or the mapping to the data dictionary, that correspond to a changed DOM element. Step 506 includes, running the ML models 118 to compile a list of changes between the DOM and its corresponding data dictionary and/or data dictionary mapping. For example, the crawler 116 may find a discrepancy in that the DOM element “l_name” does not appear in the data dictionary and/or data dictionary mapping. This can be an indication that the application and consequently the DOM has changed. The crawler 116 can trigger the ML models 118 to compile a list of changes between the DOM and the data dictionary and/or the data dictionary mappings. In this example, the ML models 118 can detect that the DOM element “l_name” is likely a change to an existing data dictionary element labeled “last_name.” Step 508 includes providing the list of changes to one or more Gen AI models 120 to generate a script 126 to update the data dictionary, and/or the mappings to the data dictionary, or other instances of the changed content blocks, based on the list of changes received from the ML models 118. For example, in addition to updating the data dictionary, and/or the mappings to a data dictionary, the script 126 can update workflow automation 128. In some embodiments, the data dictionaries can be left unchanged, and the updates, triggered by DOM changes can only be reflected in the mappings to the data dictionary. In other embodiments, when a DOM or endpoint change is detected, the data dictionary and all the instances of those changes in the mappings to the data dictionary can be updated to reflect the change. The method ends at step 510.

In some respect, the described embodiments can enable a universal self-healing application programming interface (API), where the combination of the DOM-based data dictionaries, the data dictionary mappings, and the AI-based automatic updating of the data dictionaries, and/or data dictionary mappings, amounts to a type of self-healing API and/or self-healing mappings, for transfer of data, where the underlying basis for automatic transfer of data is automatically updated, with or without input from the user. The term “universal” refers to the ability of the SCP 100 to provide a multi-application automatic data transfer platform, which can transfer data between multiple applications, regardless of whether or not the applications are integrated or share integrated APIs for transfer of data. The term “self-healing” refers to the ability of the SCP 100 to automatically update data dictionaries, mappings to the data dictionary, and the scripts for automatic data matching and data transfer. The user can engage the universal self-healing API, provided by the SCP 100, to open a plurality of applications in a single interface, where the SCP 100 can automatically detect relevant, similar or identical content blocks between the applications and automatically, or after obtaining confirmation from the user, transfer data between the content blocks, by auto-populating the content blocks in one application with data from the same or similar content blocks from another application. The described universal self-healing API implemented in the SCP 100 can improve computer technology by providing auto-population of data between distinct applications. Without the benefit of the automation provided by the described embodiments, the transfer of data can be a manual process, requiring custom coding that needs to be updated, by a human programmer, when the applications receive an update or change. As a result, the described embodiments improve the computer technology of allowing automatic and intelligent data transfer between distinct applications, without having to integrate the applications.

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

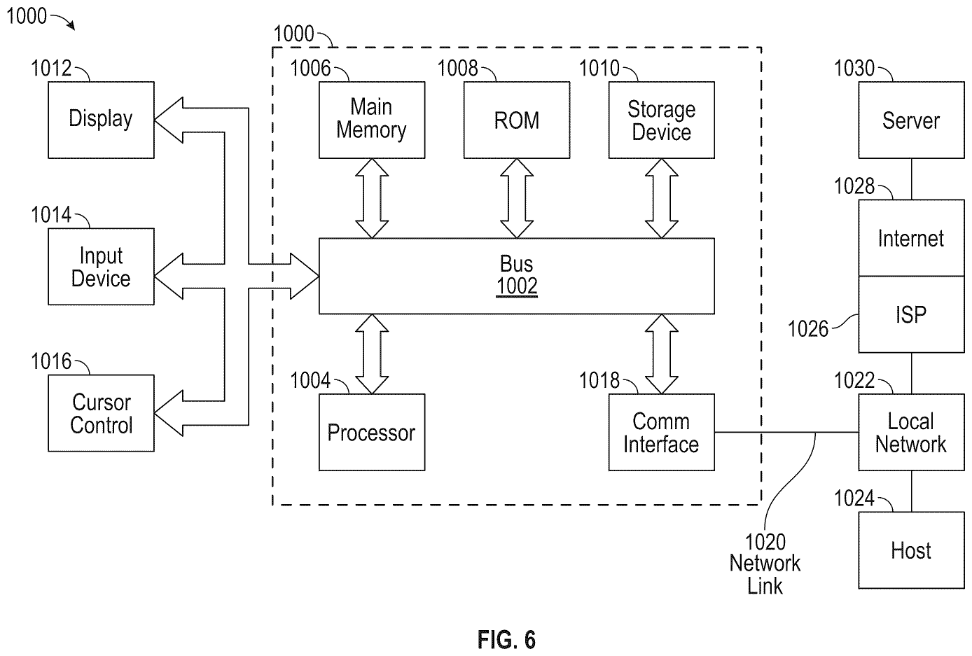

For example, FIG. 6 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infrared data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infrared signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled with bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

The described embodiments can be implemented in one or more physical servers. The term server can include a computer system or a collection of computer system that include or have access to a large language model (LLM) server, one or more processors, permanent and impermanent memory devices or modules, including non-transitory computer storage that stores program instructions for executing the methods and/or for implementing the systems described herein. The servers can interface with one another and with internal or external artificial intelligence (AI) models to provide AI model inputs and receive an AI output.

In some embodiments, the AI models, for example, the ML models or LLMs can be implemented in one or more application integrated circuits (ASICs) for an artificial intelligence neural network (AINN or ANN). Such ASICs can include a plurality of neurons organized in an array, where each neuron includes a register, a microprocessor, and each neuron receives at least one input. The ASICs can further include a plurality of synaptic circuits, each synaptic circuit including a memory for storing a synaptic weight, where each neuron is connected to at least one other neuron via one of the plurality of the synaptic circuits. However, the AI models can also be implemented in a general-purpose computer system.

Weights in a neural network are values that determine the importance of the input signals that a neuron receives. Weights are learnable parameters of the neural network. When a neuron receives an input signal, the input signal is multiplied by the weight associated with that input signal and provided to the neuron's processing element. The processing element sums all the weighted input signals that the neuron receives to determine the neuron's net input.

An activation function is applied to this net input to produce the neuron's output. The activation function introduces non-linearity into the network, allowing it to learn complex patterns and relationships within the data. Common activation functions include the sigmoid function, which maps the input to a value between 0 and 1, the hyperbolic tangent function, which maps the input to a value between −1 and 1, and the rectified linear unit (ReLU), which outputs the input directly if it is positive, otherwise it outputs zero.

The combination of weights and activation functions allows neural networks to approximate complex functions and make predictions or classifications based on input data. During training, the network adjusts the weights through a process called backpropagation, which involves calculating the gradient of the loss function with respect to each weight and updating the weights in the direction that minimizes the loss. This process is repeated iteratively until the network achieves a satisfactory level of accuracy.

In a hardware implementation of the described embodiments, one or more artificial intelligence (AI) models can be executable on one or more processors, or microprocessors coupled to memory devices. The memory devices can store the executable instructions, related to the AI models. The stored executable instructions can program the processors or microprocessors generate a plurality of neurons organized in an array in memory devices. Each neuron can be implemented in the hardware to include or be connected to a register implemented in the processing elements, and to receive at least one neuron input. Each neuron can also be connected to a plurality of synaptic circuits, where each synaptic circuit, in turn includes additional neurons implemented in a synaptic memory for storing a synaptic weight, and an activation function. Each neuron is connected to at least one other neuron via one of the plurality of synaptic circuits. The execution of the AI models can include adjusting the synaptic weights and executing the activation functions in a plurality of executions or runs of the AI models to generate an output.

The described embodiments can be implemented in various artificial intelligence models, or use various artificial intelligence techniques alone or in combination with one another, including for example, machine learning (ML) models, generative AI models, neural networks (NNs), deep neural networks (DNNs), convolutional neural networks (CNNs), natural language processing (NLP) models, large language models(LLMs) , decision trees, random forests, support vector machines (SVMs), learning vector quantization (LVQ), linear regression, logistic regression, linear discriminant analysis, naive Bayes, K-nearest neighbors, and others.

### Examples

It will be appreciated that the present disclosure may include any one and up to all of the following examples.
Example 1: A method comprising: accessing a primary application, the primary application comprising a primary application document object model (DOM) and one or more primary application endpoints, the primary application DOM further comprising primary application content blocks; generating and/or updating a primary application mapping to a data dictionary, based on the primary application DOM, wherein the primary application mapping to the data dictionary comprises content blocks in the primary application DOM, matching to content blocks in the data dictionary; detecting a change in the primary application, the change comprising a change in the primary application DOM; with one or more artificial intelligence models, updating the primary application data dictionary mapping, by remapping the changed primary application DOM to one or more corresponding content blocks in the data dictionary; accessing a secondary application DOM; generating and/or updating a secondary application mapping to the data dictionary; with the artificial intelligence models, determining matching content blocks between the primary and secondary applications, based on determining matching content blocks between the primary and secondary application mappings to the data dictionary; and transferring data from the primary application to the secondary application in the matched content blocks, wherein the transferring of the data comprises: generating a user interface comprising a primary application user interface pod and a secondary application user interface pod; auto-populating relevant fields in the secondary application user interface pod from the primary application user interface pod, based at least in part on transferring data from the primary application DOM to the second application DOM.
Example 2: The method of Example 1, wherein a machine learning model determines matching content blocks between the primary and the secondary applications.
Example 3: The method of some or all of Examples 1 and 2, further comprising: a machine learning model, identifying matched primary application content blocks in the primary application mapping to the data dictionary with the changed content blocks in the changed primary application DOM.
Example 4: The method of some or all of Examples 1-3, further comprising: a machine learning model, identifying matched primary application content blocks in the primary application mapping to the data dictionary corresponding with the changed content blocks in the changed primary application DOM; a generative artificial intelligence model, generating a script, based on the changed content blocks, wherein the script when executed updates the changed content blocks in the primary application mapping to the data dictionary.
Example 5: The method of some or all of Examples 1-4, wherein the machine learning model and the generative artificial intelligence model are executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.
Example 6: The method of some or all of Examples 1-5, further comprising: with machine learning models, categorizing the content blocks in the primary application DOM; determining content blocks subject to regulation or security restrictions; and applying content controls to the determined content blocks, based on the regulation or security restrictions.
Example 7: The method of some or all of Examples 1-6, further comprising generating a confidence score along with each matched content blocks between the primary and secondary applications; and obtaining an input before confirming a match with a confidence score lower than a selected threshold.
Example 8: The method of some or all of Examples 1-7, further comprising: receiving a workflow automation request comprising a mapping of content block fields between the primary and secondary applications; with an artificial intelligence model, determining the matched content blocks in the workflow automation; and updating the workflow automation, based on the detected changes in the DOM.
Example 9: The method of some or all of Examples 1-8, further comprising: detecting a secondary application DOM change; with a machine learning model, determining a corresponding content block in the data dictionary to the secondary application DOM change and with a generative AI model, updating the secondary application mapping to the data dictionary, based at least in part on the detected second application DOM change.
Example 10: The method of some or all of Examples 1-9, wherein the change comprises a location and/or a label change of an element of the primary application.
Example 11: A non-transitory computer storage medium that stores executable program instructions that, when executed by one or more computing devices, configure the one or more computing devices to perform operations comprising: accessing a primary application, the primary application comprising a primary application document object model (DOM) and one or more primary application endpoints, the primary application DOM further comprising primary application content blocks; generating and/or updating a primary application mapping to a data dictionary, based on the primary application DOM, wherein the primary application mapping to the data dictionary comprises content blocks in the primary application DOM, matching to content blocks in the data dictionary; detecting a change in the primary application, the change comprising a change in the primary application DOM; with one or more artificial intelligence models, updating the primary application data dictionary mapping, by remapping the changed primary application DOM to one or more corresponding content blocks in the data dictionary; accessing a secondary application DOM; generating and/or updating a secondary application mapping to the data dictionary; with the artificial intelligence models, determining matching content blocks between the primary and secondary applications, based on determining matching content blocks between the primary and secondary application mappings to the data dictionary; and transferring data from the primary application to the secondary application in the matched content blocks, wherein the transferring of the data comprises: generating a user interface comprising a primary application user interface pod and a secondary application user interface pod; auto-populating relevant fields in the secondary application user interface pod from the primary application user interface pod, based at least in part on transferring data from the primary application DOM to the second application DOM.
Example 12: The non-transitory computer storage of Example 11, wherein a machine learning model determines matching content blocks between the primary and the secondary applications.
Example 13: The non-transitory computer storage of some or all of Examples 11 and 12, wherein the operations further comprise: a machine learning model, identifying matched primary application content blocks in the primary application mapping to the data dictionary with the changed content blocks in the changed primary application DOM.
Example 14: The non-transitory computer storage of some or all of Examples 11-13, wherein the operations further comprise: a machine learning model, identifying matched primary application content blocks in the primary application mapping to the data dictionary corresponding with the changed content blocks in the changed primary application DOM; a generative artificial intelligence model, generating a script, based on the changed content blocks, wherein the script when executed updates the changed content blocks in the primary application mapping to the data dictionary.
Example 15: The non-transitory computer storage of some or all of Examples 11-14, wherein the machine learning model and the generative artificial intelligence model are executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.
Example 16: The non-transitory computer storage of some or all of Examples 11-15, wherein the operations further comprise: with machine learning models, categorizing the content blocks in the primary application DOM; determining content blocks subject to regulation or security restrictions; and applying content controls to the determined content blocks, based on the regulation or security restrictions.
Example 17: The non-transitory computer storage of some or all of Examples 11-16, wherein the operations further comprise generating a confidence score along with each matched content blocks between the primary and secondary applications; and obtaining an input before confirming a match with a confidence score lower than a selected threshold.
Example 18: The non-transitory computer storage of some or all of Examples 11-17, wherein the operations further comprise: receiving a workflow automation request comprising a mapping of content block fields between the primary and secondary applications; with an artificial intelligence model, determining the matched content blocks in the workflow automation; and updating the workflow automation, based on the detected changes in the DOM.
Example 19: The non-transitory computer storage of some or all of Examples 11-18, wherein the operations further comprise: detecting a secondary application DOM change; with a machine learning model, determining a corresponding content block in the data dictionary to the secondary application DOM change and with a generative AI model, updating the secondary application mapping to the data dictionary, based at least in part on the detected second application DOM change.
Example 20; The non-transitory computer storage of some or all of Examples 11-19, wherein the change comprises a location and/or a label change of an element of the primary application.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including, hard drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A method comprising:
accessing a primary application, the primary application comprising a primary application document object model (DOM) and one or more primary application endpoints, the primary application DOM further comprising primary application content blocks;
generating and/or updating a primary application mapping to a data dictionary, based on the primary application DOM, wherein the primary application mapping to the data dictionary comprises content blocks in the primary application DOM, matching to content blocks in the data dictionary;
detecting a change in the primary application, the change comprising a change in the primary application DOM;
with one or more artificial intelligence models, updating the primary application data dictionary mapping, by remapping the changed primary application DOM to one or more corresponding content blocks in the data dictionary;
accessing a secondary application DOM;
generating and/or updating a secondary application mapping to the data dictionary;
with the artificial intelligence models, determining matching content blocks between the primary and secondary applications, based on determining matching content blocks between the primary and secondary application mappings to the data dictionary; and
transferring data from the primary application to the secondary application in the matched content blocks, wherein the transferring of the data comprises:
generating a user interface comprising a primary application user interface pod and a secondary application user interface pod;
auto-populating relevant fields in the secondary application user interface pod from the primary application user interface pod, based at least in part on transferring data from the primary application DOM to the second application DOM.

2. The method of claim 1, wherein a machine learning model determines matching content blocks between the primary and the secondary applications.

3. The method of claim 1, further comprising:
a machine learning model, identifying matched primary application content blocks in the primary application mapping to the data dictionary with the changed content blocks in the changed primary application DOM.

4. The method of claim 1, further comprising:
a machine learning model, identifying matched primary application content blocks in the primary application mapping to the data dictionary corresponding with the changed content blocks in the changed primary application DOM;
a generative artificial intelligence model, generating a script, based on the changed content blocks, wherein the script when executed updates the changed content blocks in the primary application mapping to the data dictionary.

5. The method of claim 4, wherein the machine learning model and the generative artificial intelligence model are executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

6. The method of claim 1, further comprising:
with machine learning models, categorizing the content blocks in the primary application DOM;
determining content blocks subject to regulation or security restrictions; and
applying content controls to the determined content blocks, based on the regulation or security restrictions.

7. The method of claim 1, further comprising generating a confidence score along with each matched content blocks between the primary and secondary applications; and obtaining an input before confirming a match with a confidence score lower than a selected threshold.

8. The method of claim 1, further comprising:
receiving a workflow automation request comprising a mapping of content block fields between the primary and secondary applications;
with an artificial intelligence model, determining the matched content blocks in the workflow automation; and
updating the workflow automation, based on the detected changes in the DOM.

9. The method of claim 1, further comprising:
detecting a secondary application DOM change;
with a machine learning model, determining a corresponding content block in the data dictionary to the secondary application DOM change and
with a generative AI model, updating the secondary application mapping to the data dictionary, based at least in part on the detected second application DOM change.

10. The method of claim 1, wherein the change comprises a location and/or a label change of an element of the primary application.

11. A non-transitory computer storage medium that stores executable program instructions that, when executed by one or more computing devices, configure the one or more computing devices to perform operations comprising:
accessing a primary application, the primary application comprising a primary application document object model (DOM) and one or more primary application endpoints, the primary application DOM further comprising primary application content blocks;
generating and/or updating a primary application mapping to a data dictionary, based on the primary application DOM, wherein the primary application mapping to the data dictionary comprises content blocks in the primary application DOM, matching to content blocks in the data dictionary;
detecting a change in the primary application, the change comprising a change in the primary application DOM;
with one or more artificial intelligence models, updating the primary application data dictionary mapping, by remapping the changed primary application DOM to one or more corresponding content blocks in the data dictionary;
accessing a secondary application DOM;
generating and/or updating a secondary application mapping to the data dictionary;
with the artificial intelligence models, determining matching content blocks between the primary and secondary applications, based on determining matching content blocks between the primary and secondary application mappings to the data dictionary; and
transferring data from the primary application to the secondary application in the matched content blocks, wherein the transferring of the data comprises:
generating a user interface comprising a primary application user interface pod and a secondary application user interface pod;
auto-populating relevant fields in the secondary application user interface pod from the primary application user interface pod, based at least in part on transferring data from the primary application DOM to the second application DOM.

12. The non-transitory computer storage of claim 11, wherein a machine learning model determines matching content blocks between the primary and the secondary applications.

13. The non-transitory computer storage of claim 11, wherein the operations further comprise:
a machine learning model, identifying matched primary application content blocks in the primary application mapping to the data dictionary with the changed content blocks in the changed primary application DOM.

14. The non-transitory computer storage of claim 11, wherein the operations further comprise:
a machine learning model, identifying matched primary application content blocks in the primary application mapping to the data dictionary corresponding with the changed content blocks in the changed primary application DOM;
a generative artificial intelligence model, generating a script, based on the changed content blocks, wherein the script when executed updates the changed content blocks in the primary application mapping to the data dictionary.

15. The non-transitory computer storage of claim 11, wherein the machine learning model and the generative artificial intelligence model are executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

16. The non-transitory computer storage of claim 11, wherein the operations further comprise:
with machine learning models, categorizing the content blocks in the primary application DOM;
determining content blocks subject to regulation or security restrictions; and
applying content controls to the determined content blocks, based on the regulation or security restrictions.

17. The non-transitory computer storage of claim 11, wherein the operations further comprise generating a confidence score along with each matched content blocks between the primary and secondary applications; and obtaining an input before confirming a match with a confidence score lower than a selected threshold.

18. The non-transitory computer storage of claim 11, wherein the operations further comprise:
receiving a workflow automation request comprising a mapping of content block fields between the primary and secondary applications;
with an artificial intelligence model, determining the matched content blocks in the workflow automation; and
updating the workflow automation, based on the detected changes in the DOM.

19. The non-transitory computer storage of claim 11, wherein the operations further comprise:
detecting a secondary application DOM change;
with a machine learning model, determining a corresponding content block in the data dictionary to the secondary application DOM change and
with a generative AI model, updating the secondary application mapping to the data dictionary, based at least in part on the detected second application DOM change.

20. The non-transitory computer storage of claim 11, wherein the change comprises a location and/or a label change of an element of the primary application.
